(19) United States
(12) Patent Application Publication
(10) Pub. No.: US 2011/0250360 A1
(43) Pub. Date: Oct. 13, 2011

(54) COATING SYSTEM AND METHOD FOR THE SERIES COATING OF WORKPIECES

(76) Inventors: Jürgen Körmoci, Sersheim (DE); Vassilios Sougioltzis, Bietigheim-Bissingen (DE)

(21) Appl. No.: 12/518,827

(22) PCT Filed: Dec. 5, 2007
(86) PCT No.: PCT/EP07/10560

§ 371 Date: Jun. 27, 2011

(30) Foreign Application Priority Data
Dec. 11, 2006 (DE) 10 2006 058 350.7

(51) Int. Cl. B05D 1/02; B05B 15/12; B05B 13/00

(52) U.S. Cl. 427/427.2; 118/300

(57) ABSTRACT

The series painting of vehicle bodies is carried out by painting robots (6, 7) which are mounted in the spray cabin (1) on a portal structure (11, 12, 13) so as to be stationary above the bodies (2).

### CROSS-REFERENCE TO RELATED APPLICATIONS

This application is a National Phase application claiming the benefit of International Application No. PCT/EP2007/010560, filed Dec. 5, 2007, which claims priority to German Patent Application No. DE 10 2006 058 350.7, filed Dec. 11, 2006, the complete disclosures of which are hereby incorporated in by reference in their entireties.

### FIELD

The present disclosure relates to a coating plant and a gantry structure for a series coating of workpieces such as, for exam, vehicle bodies, and also to a corresponding method.

### BACKGROUND

Unlike stationary painting robots which are typically used in practice for relatively small workpieces, painting robots in coating plants for larger workpieces such as vehicle bodies are conventionally capable of linear motion on guide rails mounted on the side walls of the spray booth parallel to the conveying path of the bodies (travelling axis or “axis 7”). In most plants nowadays, during painting the bodies are conveyed through the booth in synchronism with the linear motion of the robots, but the bodies can also remain stationary during this process.

While, especially in most of the earlier plants, the guide rails were located in proximity to the booth floor or alongside the bodies (U.S. Pat. No. 4,342,536, U.S. Pat. No. 4,721,630, EP 0 084 523, EP 0 192 338, EP 0 216 482, EP 1 277 521, etc.), for various reasons it can be more effective to arrange the robot guide rails above the conveyor and, in particular, above the bodies, especially because the elevatedly arranged robots have correspondingly improved freedom of movement and robots arranged on the booth floor require substantially wider booths owing to the requisite painting distance from the body and, in the case of electrostatic painting, owing to the distance required for high-voltage insulation. The painting of vertical areas such as, in particular, the nose and tail regions of the bodies, is also made easier. Other reasons are the fact that the elevatedly arranged guide rails there do not restrict the view through the side wall of the booth and accessibility to the bodies as much and/or are less soiled by overspray, which is carried away downwards by the customary air flow in the booths. A possible further advantage of elevatedly mounted robots is that they do not disrupt the air flow from the booth roof downwards along the sides of the bodies into the booth floor as much as robots that are located on the floor alongside the body and that restrict the airway directly at the body, a fact which can lead to an undesirable increase in the flow rate.

In the case of each of the painting plants for vehicle bodies known from WO 2004/037430 and EP 1 609 532, a plurality of painting robots are located on two parallel guide rails which are in turn mounted on a frame enclosure arranged in the interior of the booth and having four upright legs interconnected by cross support members in a similar manner to the known gantry robot structures (European standard EN ISO 8373, 1996 D, page 7 “Gantry robots”; DE 4111889; etc.). One advantage of these gantry enclosures is that they can be easily erected in already existing painting booths without the need for considerable new construction or reconstruction of the booth.

WO 01/68267 also discloses a painting zone in a painting booth for vehicle bodies having an air supply through the upper roof wall and having two accessible control regions that are arranged vertically one above the other on each of the side walls, with robot guide rails arranged elevatedly above the conveyor being incorporated into modular prefabricated side-wall elements of the booth. Unlike the enclosure according to WO 2004/037430 or EP 1 609 532, the supporting structures of the guide rails are separate from each other in the booth interior, thus eliminating cross support members thereof in the booth interior. On the floor of this known painting booth, which is formed as usual by a grid structure for carrying away the vertical air flow, additional guide rails for further robots are mounted alongside the lower control region below the elevatedly arranged guide rails, the robots of the lower level being painting robots and the upper robots being door or bonnet openers. Further coating zones with guide rails arranged above the bodies for painting robots and/or handling robots are described in the patent application EP 06010550.9.

Painting booths for vehicle bodies having robot guide rails mounted vertically one above the other on the booth walls and having a plurality of painting zones arranged one downstream of the other along the transport path of the conveyor are known from EP 0745429.

The various approaches outlined above each require a relatively high degree of effort to construct the coating plants, a large capital outlay and control complexity, and high operating costs. Accordingly, the present disclosure is directed to providing a coating plant for vehicle bodies and a corresponding method, each of which require less construction effort, capital outlay and control complexity, and lower operating costs than the above approaches.

### DESCRIPTION OF THE DRAWINGS

Various exemplary illustrations are explained in detail with reference to the examples shown simplified to some extent but substantially true to scale in the drawings. The exemplary illustrations set forth herein are not intended to be exhaustive or otherwise limit or restrict the claims to the precise fowls and configurations shown in the drawings and disclosed in the following detailed description, in which:

FIG. 1 shows the cross section of a painting booth having painting robots mounted in a stationary manner on a gantry structure; and

FIG. 2 shows a plan view of the robot arrangement in two successive painting booths according to FIG. 1.

### DETAILED DESCRIPTION

The present disclosure generally provides extremely narrow spray booths that can be achieved or used by dispensing with the mobility of the robots arranged on a gantry structure (that is to say the “gantry robots”). For the painting of car bodies the booth width can be reduced to, for example, approximately 4 to 4.5 m.

The robots can typically be coating robots, in particular painting robots, to which reference is made hereafter. They can, however, also be robots for other purposes, in particular handling robots such as, notably, door manipulators and/or bonnet manipulators, which can also optionally be positioned alongside a coating robot. Accordingly, the tool can, in particular, be an atomiser for the coating material or an opener tool for the doors or bonnets of vehicle bodies.

In the case in point, namely painting robots, the booth width required across the conveying path of the bodies is, first, reduced in that stationary painting robots are mounted by their base body not on the booth floor but on the gantry structure, that is to say substantially higher and advantageously above the body roofs, such that the above-mentioned problems with regard to the atomisers being an adequate painting distance from the body surfaces and high-voltage insulation are reduced. The elevatedly arranged painting robots have a much better workspace than floor-mounted robots arranged in a known manner alongside or below the bodies. An even narrower booth is, however, also made possible by the fact of dispensing with the relatively wide guide rails of the known gantry painting robots and the wide energy chains with movable control and supply cables that are required for mobility.

Narrow spray booths again have considerable advantages not only in terms of construction effort and capital outlay, which are dependent on the size of and space required by the booth, but in particular also in terms of operating costs, which are substantially governed by the air flow required in the booth. The booth air must not only have the correct flow rate but also satisfy strict quality conditions in terms of purity, temperature and humidity, and the expenditure required therefor is dependent on the volume of air required. This expenditure is reduced by the various examples provided herein, since the volumetric flow rate of air per unit of time is less in a narrower booth than in a wider booth.

Dispensing with robot mobility, as described in the examples herein, also eliminates the construction effort associated therewith, as well as the control complexity that known painting plants require for the linear motion of the robots.

Second, the exemplary illustrations also have the fundamental advantage that gantry structures with robots can be simply installed or incorporated in spray booths already in existence or that have been erected with minimal construction effort and, in particular, without solid stable walls.

In one exemplary illustration, the supports and longitudinal beams of the gantry structure are advantageously arranged on the outer face of the painting booth, such that only the base body proper of each of the robots is located inside the booth and, at the appropriate point around the base body, the inner face of the booth is free from other components (known as a “clean wall design”). This arrangement has the added advantage that the cables and hoses running to the robot can be located wholly outside the painting booth. As a rule it is easier to install the supports, longitudinal beams, cabling and hosing, and also the control panel outside the painting booth, and this is particularly advantageous if the gantry structure as described in the various exemplary illustrations is to be installed for an already existing booth and is to replace the hitherto existing machinery thereof as appropriate.

The advantages of the exemplary illustrations explained herein are all the more important since a typical coating plant for vehicle bodies as described herein may include not only one but a plurality of painting zones, each with their own spray booths which are separate from each other and in which the bodies are each painted by robots.

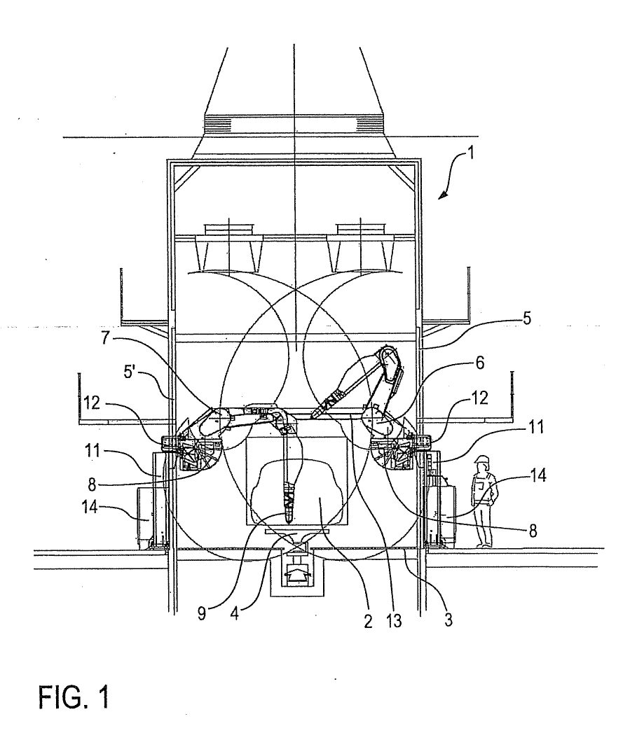

In the spray booth 1 shown in FIG. 1 the paint is applied to vehicle bodies 2 under the requisite climatic conditions. The spray mist produced during the painting process is absorbed by the air flowing vertically through the booth and is carried away for washing out. Air is supplied to the booth by an incoming-air system. The fresh air taken in from outside with fans is, in a plurality of stages, filtered, heated and humidified, is brought into the booth uniformly via a pressure chamber through a filter roof at a defined rate of air fall and is carried away through the grid floor 3. Painting booths in which bodies can be transported by a floor conveyor 4, are provided, for example, in DE 20313854 U1.

The bodies 2 are coated by, for example, four or more painting robots which are arranged on the two side walls 5 and 5′ of the booth 1 and of which the painting robots 6 and 7 are visible in FIG. 1. These painting robots can each have a base body 8 which supports the usual multi-axis arm structure of an articulated-arm robot with the two arms shown and, attached to a wrist, the atomiser 9, conventionally an electrostatic rotary atomiser or an air atomiser. The base bodies 8 of the robots can, as shown, be arranged approximately at the height of the roof of the bodies 2 conveyed through the painting booth.

The side walls 5 and 5′ of the booth 1 can be made from relatively thin material with glass windows or the like and are themselves not intended for or capable of carrying and supporting the elevatedly positioned painting robots 6 and 7. Rather, for mounting the painting robots there is a gantry structure provided specifically therefor and substantially consisting of a horizontal rectangular frame standing on legs in proximity to the four corners. The two vertical supports 11 visible in FIG. 1 on the outer faces of the side walls 5 and 5′ and two further supports (not visible) spaced apart therefrom in the conveying direction of the bodies 2 act as legs. The frame of the gantry structure consists of two longitudinal beams 12 which, in the example shown, are incorporated into the side walls 5 and 5′ or may be advantageously mounted on the outer face of the side wall and which extend in the conveying direction of the bodies 2 and each rest on two supports 11 spaced apart in the conveying direction, and of two cross support members 13 which fixedly interconnect the two longitudinal beams 12, at the ends thereof and in proximity to the supports 11, and of which only one is visible in FIG. 1. In the example shown, the cross support members have end portions leading obliquely downwards to the longitudinal beams 12 and extend above the bodies 2 across the conveying direction thereof through the booth 1 from the one side wall 5 to the other side wall 5′. Diverging from this specific example as appropriate, the gantry structure can in principle have the design as described in WO 2004/037430, EP 1 603 532 and EN ISO 8373. Unlike the arrangements shown in WO 2004/037430, EP 1 603 532 and EN ISO 8373, however, the longitudinal beams 12 have no guide rails for moving the painting robots 6 and 7, which are in fact, rigidly secured to the respective longitudinal beam 12 by their base body 8. As a result of this stationary robot arrangement, the exemplary illustrations achieve a booth with a width between the inner faces of the side walls which can be not only considerably less than if the robots are arranged in a stationary manner on the booth floor alongside the bodies but also less than with the known gantry structures provided with the conventional travel rails. For example, a booth width of 4.6 m, measured between the inner faces of the vertical side walls 5 and 5′, is sufficient for the painting of the different bodies of typical passenger motor vehicles. The length of the booth 1 measured in the conveying direction can, for example, be approximately 7 m.

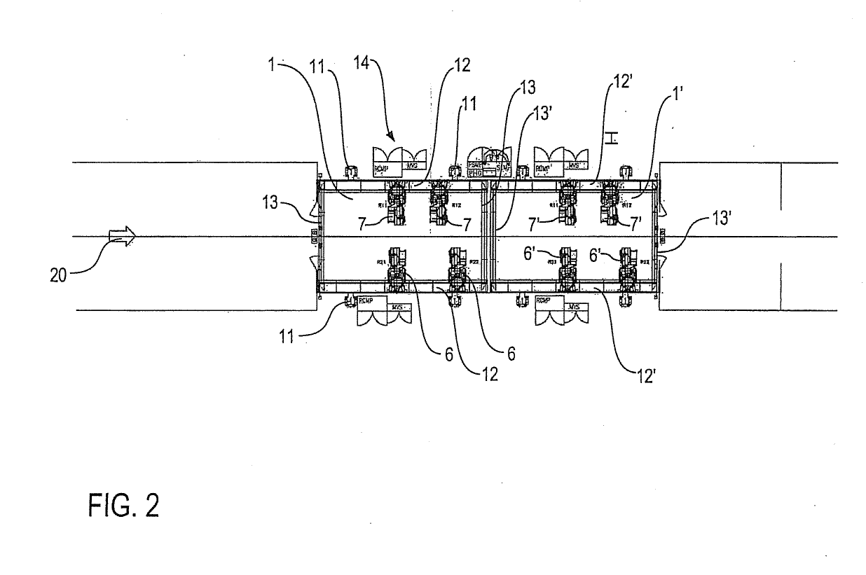

As shown, for example in FIG. 2, on the outer face of the side walls 5 and 5′ the usual switchgear and control cabinets 14 for the robot control system and for the application technology, etc. can usefully be located between the supports 11 that are spaced apart lengthwise of the conveying direction.

Above the supports 11 and longitudinal beam 12 the outer face of the booth can be provided with further usable surfaces which can also be accessible for observing the painting operation. The reachable-space curves (workspace or “kidney-shaped” workspace) of the painting robots 6 and 7 are also shown in FIG. 1 to illustrate the respective freedom of movement thereof.

The exemplary illustrations herein are not limited to the gantry structure between the two side walls 5 and 5′ as shown in FIG. 1. Merely as examples, it would also be conceivable to arrange only one longitudinal beam in an elevated position in each of the two side walls of the spray booth and to stabilise this beam outside the booth by means of support elements extending across the conveying direction. Some examples are described inter alia in patent application EP 06010550.9, mentioned above. It is also possible for fewer or more than the two stationary robots shown to be provided on one booth side.

FIG. 2 shows two spray booths 1 and 1′ according to FIG. 1 arranged one downstream of the other in the conveying direction 20 in a painting line. Each of these spray booths 1 and 1′ fauns one of the different painting zones into which a painting line is usually subdivided, and includes a gantry structure as described above, that is to say having the two longitudinal beams 12 and 12′ and having the two cross support members 13 and 13′ respectively. The longitudinal beams 12 and 12′ can, as shown, extend over the entire length of the booth 1 and 1′, respectively, between the front and back ends thereof, at which the booths can usually be closed by thin, mechanically non-load-bearing, e.g. transparent end walls (“silhouettes”), leaving only openings for the bodies. The two spray booths 1 and 1′ and hence the two gantry structures can be closely adjacent lengthwise of the conveying direction; as shown, the spacing can, for example, be approximately 1 m or less.

The painting robots 6 and 7 and 6′ and 7′, respectively, of the spray booths 1 and 1′ are distributed at useful positions between the two cross support members 13 and 13′, respectively, lengthwise of the conveying direction 20, with each of these four robots of one booth coating a different surface region of the bodies from the other three robots. The arrangement of the two painting robots 6 and 6′ on the one side and of the other two painting robots 7 and 7′ on the other side of the spray booth is thus selected according to the painting scheme of the plant such that, in the booth, the entire outer surface of the bodies can advantageously be painted in the simplest manner and with as little mutual hindrance of the robots as possible and especially in the shortest time. For these reasons it can also be useful for the painting robots, such as e.g. 7, on the longitudinal beam 12 of the one side wall of the spray booth to be spaced apart from each other and/or to be spaced apart from the cross support members 13 by distances different from the painting robots 6 on the longitudinal beam 12 of the other side wall. In particular, two painting robots arranged facing each other on opposite sides of the booth can, as shown, be mutually offset lengthwise of the conveying direction 20, that is to say be spaced different distances apart from the cross support members 13. As can be seen in FIG. 1, one of the robots can, for example, be specifically deployed to paint the nose or tail region of the bodies.

When the bodies are transported through the spray booths 1 and 1′ in the conveying direction 20 by the conveyor 4 (FIG. 1), initially a first layer of paint is applied to the body in the spray booth 1. Since this one layer is not sufficient in typical cases, a second layer of paint is then applied in the spray booth 1′, with the painting robots being able to be programmed and controlled for the same movements as in the first booth and therefore also being able to be distributed in the same arrangement lengthwise of the conveying direction. Robots mutually corresponding in their position in the spray booths 1 and 1′ therefore may paint the same surface regions of the bodies.

One of the advantages of applying the two layers in two spray booths 1 and 1′ separate from each other is that, in the event of a malfunction in one of the two painting zones, the automatic painting operation can be continued in the other zone and the then missing other layer of paint can be applied in another manner.

In other cases the purpose of arranging a second spray booth 1′ after the first booth 1, which is separated therefrom by the respective end walls, can be to isolate two coating zones from each other having a different air balance, for example a zone for electrostatic application with rotary atomisers from a zone with air atomisers, in which different rates of air fall are necessary. In such plants or also in other plants, instead of the example described above it can also be useful for the robots in the one booth to paint other surface regions of the bodies from the robots of the other booth and/or to be arranged at other positions lengthwise of the conveying path.

Two (or more) painting lines operated in parallel can also be provided—in the example considered, topcoat lines. In this case there can be present, for example, spatially parallel alongside the spray booths 1 and 1′ shown in FIG. 2 two further painting booths (not shown) identical thereto in terms of the features described here, such that the savings on installation effort and operating costs resulting from the exemplary illustrations is doubled.

Reference in the specification to “one example,” “an example,” “one embodiment,” or “an embodiment” means that a particular feature, structure, or characteristic described in connection with the example is included in at least one example. The phrase “in one example” in various places in the specification does not necessarily refer to the same example each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “the,” etc. should be read to recite one or more of the indicated elements unless a claim recites an explicit limitation to the contrary.

1.-14. (canceled)

15. A coating plant for the series coating of workpieces, determined for a spray booth through which a conveyor transports the workpieces on a conveying path parallel to side walls of the spray booth;
the coating plant having a gantry structure that includes:
at least two vertical supports which are spaced apart from each other lengthwise of the conveying path and which are one of adjoining and incorporated in one of the two side walls of the spray booth, and a longitudinal beam which interconnects said vertical supports substantially parallel to the conveying path and which likewise is one of adjoining and incorporated in the side wall of the spray booth, said longitudinal beam being arranged at a height extending beyond the upper face of the workpieces in the spray booth, and
at least one cross support member arranged across the conveying path and fixedly connected to the longitudinal beam; and
the coating plant having at least one robot, which has a base body mounted on the gantry structure and a multi-axis arm arrangement supported by the base body and also a tool,
wherein the base body of the robot is rigidly secured to the longitudinal beam of the gantry structure.

16. The coating plant according to claim 15, wherein the at least one cross support member of the gantry structure extends above the upper face of the workpieces between the two side walls of the spray booth.

17. The coating plant according to claim 15, wherein the gantry structure adjoins each of the two side walls of the booth with two vertical supports and one longitudinal beam.

18. The coating plant according to claim 15, wherein the gantry structure is at least in part incorporated in the two side walls of the spray booth.

19. The coating plant according to claim 17, wherein at least one robot is secured in a stationary manner to each of the longitudinal beams provided on the two sides of the spray booth.

20. The coating plant according to claim 15, wherein at least two robots are each rigidly secured by their base body to the longitudinal beam of the gantry structure.

21. The coating plant according to claim 20, wherein, lengthwise of the conveying path of the workpieces, the base bodies of the two robots, which bodies are secured to the longitudinal beam, are spaced apart from each other and spaced apart from the cross support member closest thereto.

22. The coating plant according to claim 21, wherein the robots on the longitudinal beam of the one side wall of the spray booth are spaced apart from each other and spaced apart from the cross support members by distances different from the coating robots on the longitudinal beam of the other side wall.

23. The coating plant according to claim 15, wherein the vertical supports and the longitudinal beams are arranged on the outer face of the side wall of the spray booth.

24. The coating plant according to claim 15, wherein the conveying path of the workpieces passes through at least two spray booths which are adjacent in the conveying direction and each of which includes a gantry structure having at least one robot rigidly secured to the longitudinal beam thereof.

25. The coating plant according to claim 15, wherein the workpieces are transported on at least two mutually parallel conveying paths through one of one spray booth and two spray booths which are adjacent in the conveying direction, and each of the mutually parallel spray booths includes a gantry structure having at least one robot rigidly secured to the longitudinal beam thereof.

26. A gantry structure of a coating plant according to claim 15.

27. A method for the series coating of workpieces in a spray booth, through which the workpieces are transported by a conveyor on a conveying path parallel to the side walls of the spray booth,
a gantry structure being provided that,
on at least one side of the spray booth, includes at least two vertical supports which are spaced apart from each other lengthwise of the conveying path, the vertical supports being one of adjoining and incorporated into the side wall of the spray booth,
includes a longitudinal beam which interconnects said vertical supports substantially parallel to the conveying path and likewise being one of adjoining and incorporated into the side wall, and which is arranged at a height extending beyond the upper face of the workpieces,
further includes at least one cross support member arranged across the conveying path and fixedly connected to the longitudinal beam,
wherein the workpieces are coated by at least two coating robots, the base body of each of which is rigidly secured to one of the longitudinal beams of the gantry structure,
with each coating robot coating different surface regions of the workpieces from the other robot or the other robots.

28. The method according to claim 27, wherein the workpieces are each coated by at least two coating robots rigidly secured on the two sides of the spray booth to respective longitudinal beams of the gantry structure, with each of these four coating robots coating a different surface region of the workpieces from the other coating robots.

29. The method according to claim 27, wherein, in the spray booth, a first layer and then, in a similar second spray booth likewise including a gantry structure having coating robots secured in a stationary manner to the longitudinal beams, a second layer is applied to the surface of the workpieces.
